(19) United States
(12) Patent Application Publication
(10) Pub. No.: US 2026/0252895 A1
(43) Pub. Date: Aug. 27, 2026

(54) METHOD AND APPARATUS FOR TRANSFORMER-BASED OPERATOR LEARNING

(71) Applicants: Robert Bosch GmbH, Stuttgart (DE); Tsinghua University, Beijing (CN)

(72) Inventors: Chengyang Ying, Beijing (CN); Hang Su, Beijing (CN); Jian Song, Beijing (CN); Jun Zhu, Beijing (CN); Li Zhang, Shanghai (CN); Songming Liu, Beijing (CN); Yinpeng Dong, Beijing (CN); Ze Cheng, Shanghai (CN); Zhengyi Wang, Beijing (CN); Zhongkai Hao, Beijing (CN)

(21) Appl. No.: 19/472,729

(22) PCT Filed: Apr. 21, 2023
(86) PCT No.: PCT/CN2023/089752

§ 371 Date: Oct. 6, 2025

(51) Int. Cl. G06N 3/09; G06N 3/045

(52) U.S. Cl. CPC G06N 3/09; G06N 3/045

(57) ABSTRACT

A computer implemented method for learning an operator mapping from multiple input functions to a solution function of partial differential equations (PDEs) based on a Transformer model is disclosed. The method includes inputting coordinates of query points and the multiple input functions to the Transformer model; encoding the coordinates of query points and the multiple input functions into feature embeddings via respective encoders; and learning the operator by minimizing a mean square error (MSE) loss between output features processed by the Transformer model and ground-truth values of the solution function.

### FIELD

Aspects of the present invention relate generally to artificial intelligence, and more particularly, to method and apparatus provided for learning an operator based on a Generate Neural Operator Transformer (GNOT).

### BACKGROUND

Partial Differential Equations (PDEs) are ubiquitously used in characterizing systems in many domains like physics, chemistry, and biology. These PDEs are usually solved by numerical methods like the finite element method (FEM). FEM discretizes PDEs using a mesh with a large number of nodes, and it is often computationally expensive for high dimensional problems. In many important tasks in science and engineering like structural optimization, it is usually needed to simulate the system under different settings and parameters in a massive and repeating manner. Thus, FEM can be extremely inefficient since a single simulation using numerical methods could take from seconds to days.

Recently, machine learning methods have been proposed to accelerate solving PDEs by learning an operator mapping from the input functions to the solutions of PDEs. By leveraging the expressivity of neural networks, such neural operators could be pre-trained on a dataset and then generalize to unseen inputs. The operators predict the solutions using a single forward computation, thereby greatly accelerating the process of solving PDEs. Much work has been done on investigating different neural architectures for learning operators. For instance, DeepONet uses a branch network and a trunk network to process input functions and query coordinates. FNO learns the operator in the spectral space. Transformer models, based on attention mechanism, are proposed since they have a larger model capacity.

However, operator learning for practical real-world problems is still highly challenging and the performance can be unsatisfactory. There are several major challenges in current methods: irregular mesh, multiple inputs, and multi-scale problems. Therefore, it is needed an approach to handle these challenges for learning operators under such sophisticated scenarios.

### SUMMARY

The following section presents a simplified summary of one or more aspects of the present invention to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the present invention in a simplified form as a prelude to the more detailed description that is presented later.

To address the aforementioned challenges such as irregular mesh, multiple inputs, and multi-scale problems, an architecture of General Neural Operator Transformer (GNOT) is provided according to the present invention, which is a scalable and flexible transformer framework for learning operators. Several key components are proposed to resolve the challenges.

First, according to an example embodiment of the present invention, it is provided a general encoding interface for different input functions and additional prior information. Moreover, a Heterogeneous Normalized Attention (HNA) block which is able to take an arbitrary number of embeddings as input is provided. Moreover, by using an aggregation of normalized multi-head cross attention, HNA is able to handle arbitrary input functions while keeping a linear complexity with respect to the sequence length. Further, a soft gating mechanism based on the mixture-of-experts (MoE) is provided. The geometric coordinates of input points are used for the gating network and it could be viewed as a soft domain decomposition.

In an aspect of the present invention, a computer implemented method for learning an operator mapping from multiple input functions to a solution function of partial differential equations (PDEs) based on a Transformer model is provided. According to an example embodiment of the present invention, the method comprises inputting coordinates of query points and the multiple input functions to the Transformer model; encoding the coordinates of query points and the multiple input functions into feature embeddings via respective encoders; and learning the operator by minimizing a mean square error (MSE) loss between output features processed by the Transformer model and ground-truth values of the solution function.

In a further aspect of the present invention, the respective encoders are Multiple Layer Perceptrons (MLPs) which do not share parameters, and the feature embeddings of the coordinates of query points and the multiple input functions each have a dimension of an integral multiple of the dimension of embedding.

In a further aspect of the present invention, the multiple input functions comprise one or more of global parameter vector, boundary shape, and/or domain distributed functions.

In a further aspect of the present invention, the multiple input functions and the solution function are discretized on irregular meshes.

In a further aspect of the present invention, the method comprises inputting information of the irregular meshes on which the multiple input functions are discretized to the Transformer model; and encoding the information into feature embeddings via respective encoders.

In a further aspect of the present invention, the information of the irregular meshes comprises subdomain indicator of mesh points, and/or edge information between mesh points.

In a further aspect of the present invention, the Transformer model is configured with multiple layers of attention block, and wherein each attention block comprises a cross-attention layer followed by a self-attention layer.

In a further aspect of the present invention, the cross-attention layer and the self-attention layer are configured with multiple heads.

In a further aspect of the present invention, the method comprises calculating, in the cross-attention layer of each attention block, cross-attention between an output feature of a prior attention block and the feature embeddings of the multiple input functions; and calculating, in the self-attention layer of each attention block, self-attention between the output feature of the prior attention block; wherein the feature embedding of the coordinates of query points is the input to the first attention block.

In a further aspect of the present invention, the cross-attention and the self-attention are calculated by first normalizing sequences of Queries and Keys with softmax function and then computing the attention output without softmax function.

In a further aspect of the present invention, the cross-attention is calculated based on an aggregation of Keys and Values obtained from the feature embeddings of all of the multiple input functions.

In a further aspect of the present invention, the cross-attention layer and the self-attention layer are followed by multiple parallel Forward Feed Networks (FFNs) respectively.

In a further aspect of the present invention, the method comprises inputting the coordinates of query points to a geometric gating block; outputting unnormalized scores for averaging the multiple parallel FFNs by the geometric gating block; and weighting processing of the cross-attention and the self-attention by the FFNs with the unnormalized scores.

In a further aspect of the present invention, the geometric gating block is an MLP which parameters is learned end-to-end; or prior information is embedded into the geometric gating block and the parameters are fixed based on the prior information.

In an aspect of the present invention, a computer implemented method for solving a Partial Differential Equation (PDE) constrained shape optimization problem in a physical system with a learned operator based on a Transformer model with one or more of the methods disclosed herein, wherein the physical system is characterized by the PDE constraints, the state variables of the PDE constraints include at least one of flow velocity or pressure. The method comprises initializing control variables that parameterizing a shape of an object; calculating the solutions of the PDE constraints with the learned operator based on input coordinates of query points; and updating the control variables by minimizing drag forces or pressure from the flow with the solutions of the PDE constraints.

In an aspect of the present invention, a computer system is provided. According to an example embodiment of the present invention, the computer system comprises one or more processors; and one or more storage devices storing computer-executable instructions that, when executed, cause the one or more processors to perform the operations of one of the methods of the present invention disclosed herein.

In an aspect of the present invention, one or more computer readable storage media storing computer-executable instructions that, when executed, cause one or more processors to perform the operations of one of the methods of the present invention disclosed herein is provided.

In an aspect of the present invention, a computer program product comprising computer-executable instructions that, when executed, cause one or more processors to perform the operations of one of the methods of the present invention disclosed herein is provided.

### BRIEF DESCRIPTION OF THE DRAWINGS

The disclosed aspects of the present invention will be described in connection with the figures that are provided to illustrate and not to limit the disclosed aspects.

FIG. 1 illustrates several major challenges in current methods, in accordance with various aspects of the present invention.

FIG. 2 illustrates an example model architecture of the proposed General Neural Operator Transformer (GNOT), in accordance with various aspects of the present disclosure.

FIG. 3 illustrates an example model architecture of the General Neural Operator Transformer (GNOT), in accordance with various aspects of the present invention.

FIG. 4 illustrates an exemplary flow chart for learning an operator based on a Transformer model, in accordance with various aspects of the present invention.

FIG. 5 illustrates an exemplary flow chart for using the learned operator, in accordance with various aspects of the present invention.

FIG. 6 illustrates an exemplary computer system, in accordance with various aspects of the present invention.

### DETAILED DESCRIPTION OF EXAMPLE EMBODIMENTS

The present invention will now be discussed with reference to several example implementations. It is to be understood that these implementations are discussed only for enabling those skilled in the art to better understand and thus implement the embodiments of the present invention, rather than suggesting any limitations on the scope of the present invention.

Various embodiments of the present invention will be described in detail with reference to the figure. Whenever possible, the same reference numbers will be used throughout the figures to refer to the same or like parts. References made to examples and embodiments are for illustrative purposes, and are not intended to limit the scope of the present invention.

PDEs are usually solved by numerical methods like the finite element method (FEM). FEM discretizes PDEs using a mesh with a large number of nodes, and it is often computationally expensive for high dimensional problems. Recently, learning partial differential equations' (PDEs) solution operators is an essential problem in machine learning, which is proposed to learn an operator mapping from the input functions to the solutions of PDEs. By leveraging the expressivity of neural networks, such neural operators could be pre-trained on a dataset and then generalize to unseen inputs. The operators predict the solutions using a single forward computation, thereby greatly accelerating the process of solving PDEs.

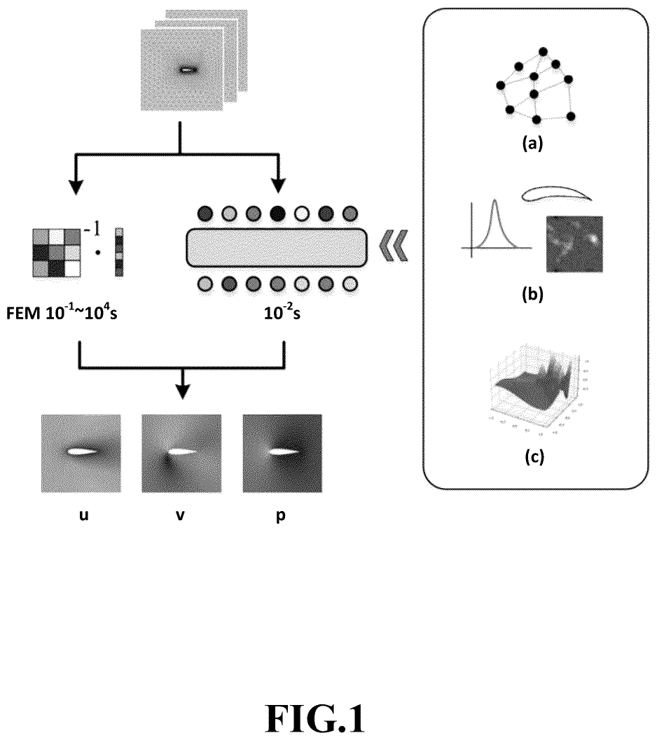

Though much work has been done on investigating different neural architectures for learning operators, operator learning for practical real-world problems is still highly challenging and the performance can be unsatisfactory. As illustrated in FIG. 1, a pre-trained neural operator using transformers is much more efficient for the numerical simulation of physical systems, with 10⁻² s compared with 10⁻¹~10⁴ s. Besides, FIG. 1 illustrates several major challenges in current methods, in accordance with various aspects of the present disclosure.

As shown in FIG. 1, the geometric shape or the mesh of practical problems (as shown in (a) of FIG. 1) are usually highly irregular. For example, the shape of the airfoil is complex. Second, the problem can rely on multiple numbers and types of input functions like boundary shape, global parameter vector or source functions as shown in (b) of FIG. 1. The challenge is that the model is expected to be flexible to handle different types of inputs. Moreover, as shown in (c) of FIG. 1, real physical systems can be multi-scale which means that the whole domain could be divided into physically distinct subdomains. The velocity field (u and v) is much more complex near the airfoil compared with the far field. It is more difficult to learn these multi-scale functions.

To address the aforementioned challenges, it is disclosed herein an architecture of General Neural Operator Transformer (GNOT), which is a scalable and flexible transformer framework for learning operators. Several key components are proposed to resolve the challenges.

First, it is proposed a general encoding interface for different input functions and additional prior information. Moreover, a Heterogeneous Normalized Attention (HNA) block which is able to take an arbitrary number of embeddings as input is proposed. Moreover, by using an aggregation of normalized multi-head cross attention, HNA is able to handle arbitrary input functions while keeping a linear complexity with respect to the sequence length. Further, it is proposed a soft gating mechanism based on the mixture-of-experts (MoE). The geometric coordinates of input points are used for the gating network and it could be viewed as a soft domain decomposition. These approaches would be discussed in details below.

Let's consider PDEs in the domain Ω⊂ [symbol] ^{d} and the function space [symbol] over Ω, including boundary shapes and source functions. Moreover, our goal is to learn an operator [symbol] from the input function space [symbol] to the solution space [symbol] , i.e., [symbol] : [symbol] → [symbol] . Here the input function space [symbol] could contain multiple different types, like boundary shapes, source functions distributed over Ω, and vector parameters of the systems. More formally, [symbol] could be represented as [symbol] = [symbol] × . . . × [symbol] × [symbol] ^{p}. For ∀a=(a¹(·), . . . , a^{m}(·), θ)∈ [symbol] , a^{j}(·)∈ [symbol] represents boundary shapes and source functions, and θ∈ [symbol] ^{p} represents parameters of the system, and [symbol] (a)=u∈ [symbol] is the solution function over Q.

For learning a neural operator, the disclosed model is trained with a dataset [symbol] ={(aₖ,uₖ)}_{1≤k≤D}, here uₖ= [symbol] (aₖ). In practice, since it is difficult to express the function directly, the input functions and the solution function are typically discretized on irregular meshes over the domain Ω using any suitable mesh generation algorithm, for example but not limiting, Delaunay method, Spatial decomposition-based method, or Advancing-Front method.

For an input function aₖ, it can be discretized on the mesh

$${\{ {x}_{i}^{j} ∈ Ω \}}_{1 ⩽ i ⩽ {N}_{j}}^{1 ⩽ j ⩽ m}$$

and the discretized

$${a}_{k}^{j} is {\{ ( {x}_{i}^{j} , {a}_{k}^{i , j} ) \}}_{1 ⩽ i ⩽ {N}_{j}} , here {a}_{k}^{i , j} = {a}_{k}^{j} ( {x}_{i}^{j} ) .$$

In a word, the input functions aₖ are represented as

$${𝒜}_{k} = {\{ ( {x}_{i}^{j} , {a}_{k}^{i , j} ) \}}_{1 ⩽ i ⩽ {N}_{j}}^{1 ⩽ j ⩽ m} ⋃ {θ}_{k} .$$

For the solution function uₖ, it can be discretized on mesh {yᵢ∈Ω}_{1≤i≤N′} and the discretized uₖ is

$${\{ ( {y}_{i} , {u}_{k}^{i} ) \}}_{1 ⩽ i ⩽ {N}^{′}} , here {u}_{k}^{i} = {u}_{k} ( {y}_{i} ) .$$

For modeling the operator [symbol] , a parameterized neural network [symbol] _{w} is used, which receives the input [symbol] ₖ (k=1, . . . , D) and outputs

$${\tilde{𝒢}}_{w} ( {𝒜}_{k} ) = {\{ {\tilde{u}}_{k}^{i} \}}_{1 ⩽ i ⩽ {N}^{′}}$$

to approximate uₖ. The goal of learning the operator is to minimize the mean square error (MSE) loss between the prediction and data as

$${min}_{w ∈ W} \frac{1}{D} {\sum }_{k = 1}^{D} \frac{1}{{N}^{′}} {‖ {\tilde{𝒢}}_{w} ( {𝒜}_{k} ) - {\{ {u}_{k}^{i} \}}_{1 ⩽ i ⩽ {N}^{′}} ‖}_{2}^{2} \qquad ( 1 )$$

where w is a set of the network parameters and W is the parameter space.

Transformers are a popular architecture to learn operators due to their ability to handle irregular mesh and strong expressivity. It embeds the input mesh points into queries Q, keys K, and values V using Multiple Layer Perceptrons (MLPs) and computes their attention. However, the computation of attention still has many limitations due to several challenges.

First, the problem might have multiple different (types) input functions in practical cases. The model needs to be flexible and efficient to take arbitrary numbers of input functions defined on different meshes with different numerical scales. To resolve the problem, a general input encoding protocol is disclosed and different input functions and other available prior information can be embedded using MLPs.

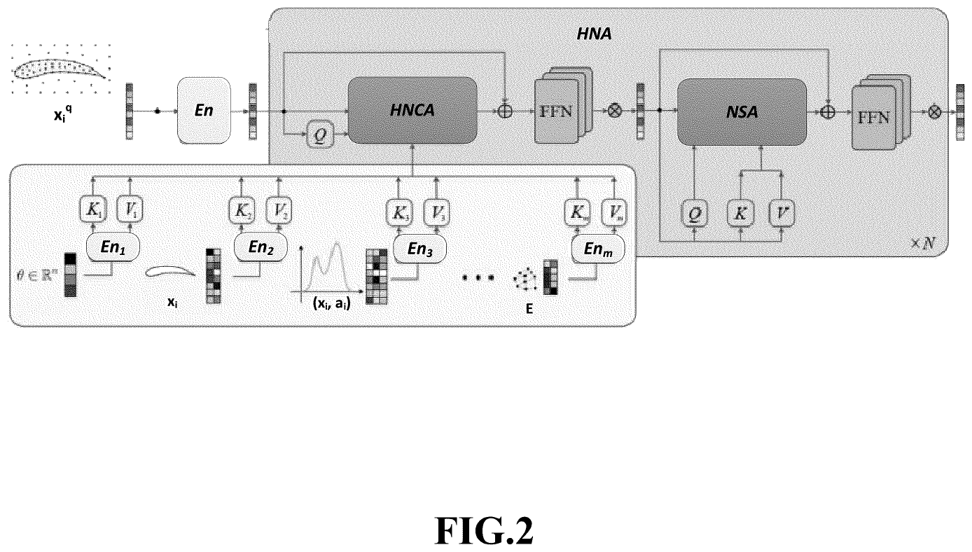

FIG. 2 illustrates an example model architecture of the proposed General Neural Operator Transformer (GNOT), in accordance with various aspects of the present disclosure.

The model takes positions of query points denoted by

$${\{ {x}_{i}^{q} \}}_{1 ⩽ i ⩽ {N}_{q}}$$

and input functions as input. The positions of query points could be mapped to query embedding X∈ [symbol] ^{N}^{_{q}}^{·n}^{ₑ} using a multiple layer perceptron. In practice, the input functions may have several different formats and shapes as shown in FIG. 2. It is disclosed herein that an encoding protocol could be used to process them to get the feature embedding Y∈ [symbol] ^{Nn}^{ₑ}, where N could be arbitrary dimension and nₑ is the dimension of embedding. Therefore, each of the feature embedding Y would have a dimension of an integral multiple of the dimension of embedding nₑ. Y is referred to as the conditional embedding herein since it encodes information of input functions and extra information. Simple multiple layer perceptrons f_{w} can be used to map the inputs to the embedding. It should be noted that one individual MLP for each input function is used so they do not share parameters, which are shown as En, En₁, En₂ . . . . Enₘ in FIG. 2. Some example input functions are listed below, but any suitable types of inputs are possible with the disclosed encoding protocol.
Parameter vector θ∈ [symbol] ^{p}: the parameter vector could be directly encoded using the MLP, i.e., Y=f_{w}(θ) and Y∈ [symbol] ^{1×n}^{ₑ}.
Boundary shape {xᵢ}_{1≤i≤N}: If the solution relies on the shape of the boundary, it is proposed to extract all these boundary points as input function and embed the position of these points with MLP. Specifically, Y=(f_{w}(xᵢ))_{1≤i≤N}∈ [symbol] ^{Nn}^{ₑ}.
Domain distributed functions {(xᵢ, aᵢ)}_{1≤i≤N}: If the input function is distributed over a domain or a mesh, it is needed to encode both the position of nodes and the function values, i.e. Y=(f_{w}(xᵢ, aᵢ)_{1≤i≤N}∈ [symbol] ^{Nn}^{ₑ}.

In a further example, besides these types of input functions, some additional prior like domain knowledge could also be encoded for specific problems using such a framework in a flexible manner which might improve the model performance. For example, the extra features of mesh points {(xᵢ, zᵢ)}_{1≤i≤N} and edge information of the mesh

$${\{ ( {x}_{i}^{src} , {x}_{i}^{dst} , {e}_{i} ) \}}_{1 ⩽ i ⩽ N}$$

could be encoded. For example, the extra features could be the subdomain indicator of mesh points and the edges shows the topology structure of these mesh points. This extra information is usually generated when collecting the data by solving FEMs. Also, MLPs are used to encode them into Y=(f_{w}(xᵢ,zᵢ))_{1≤i≤N} and Y=(f_{w}(xᵢ,zᵢ))_{1≤i≤N}.

With multiple different (types) input functions encoded into feature embeddings and input to the model, they would be processed by multiple attention blocks, named Heterogeneous Normalized Attention (HNA) block herein, each comprising a cross-attention layer followed by a self-attention layer, wherein the output of a prior attention block would be an input to a subsequent attention block.

Specifically, a Heterogeneous Normalized Cross-Attention layer which is able to take an arbitrary number of embeddings as input is shown as HNCA in FIG. 2, and a subsequent Normalized Self-Attention layer is shown as NSA in FIG. 2. The heterogeneous normalized cross attention is calculated between features of query points X and conditional embeddings {Yₗ}_{1≤l≤N}, and then a normalized self-attention is calculated based on X.

By “Heterogeneous”, it means that different MLPs are used to compute Keys and Values from different input features that ensure model capacity. Besides, the outputs of different attention outputs are normalized and all outputs are aggregated. In an example, “mean” could be used as the aggregation function to average all outputs. The normalization operation ensures numerical stability and also promotes the training process.

For a Transformer model, it typically has three sequences called Queries {qᵢ}_{1≤i≤N}, Keys {kᵢ}_{1≤i≤M} and values {vᵢ}_{1≤i≤M}. The attention is calculated as follows:

$${z}_{t} = {\sum }_{i} \frac{exp ( {q}_{t} \cdot {k}_{i} / τ )}{{\sum }_{j} exp ( {q}_{t} \cdot {k}_{j} / τ )} {v}_{i} \qquad ( 2 )$$

where τ is a hyperparameter. For self-attention, q, k, v are obtained by applying a linear transformation to input sequence X∈ [symbol] ^{N}^{_{q}}^{·n}^{ₑ}, i.e., qᵢ=W_{q}xᵢ, kᵢ=Wₖxᵢ, vᵢ=Wᵥxᵢ. For cross attention models, q comes from the query sequence X while keys and values come from another sequence Y=(yᵢ)_{1≤i≤N}, i.e., qᵢ=W_{q}xᵢ, kᵢ=Wₖyᵢ, vᵢ=Wᵥyᵢ.

Since the computational cost of the attention of Eq. (2) is O(N²nₑ) for self-attention and O(NMnₑ) for cross attention, where nₑ is the dimension of embedding. For problems of learning operators, data usually consists of thousands to even millions of points. The computational cost is unaffordable using vanilla attention with quadratic complexity. Thus, in another example, it is disclosed a novel attention layer with a linear computational cost that could handle long sequences.

First, sequences of Queries and Keys can be normalized respectively as follows:

$${\tilde{q}}_{i} = Softmax ( {q}_{i} ) = {( \frac{{e}^{{q}_{ij}}}{{\sum }_{j} {e}^{{q}_{ij}}} )}_{j = 1 , … {n}_{e}} \qquad ( 3 )$$

$${\tilde{k}}_{i} = Softmax ( {k}_{i} ) = {( \frac{{e}^{{k}_{ij}}}{{\sum }_{j} {e}^{{k}_{ij}}} )}_{j = 1 , … {n}_{e}} \qquad ( 4 )$$

Then the attention output can be computed without softmax function using the following equation:

$${z}_{t} = {\sum }_{i} \frac{{\tilde{q}}_{t} \cdot {\tilde{k}}_{i}}{{\sum }_{j} {\tilde{q}}_{t} \cdot {\tilde{k}}_{j}} \cdot {v}_{i} \qquad ( 5 )$$

We denote αₜ=(Σⱼ \tilde{q}ₜ·\tilde{k}ⱼ)⁻¹ and the efficient attention could be represented by:

$${z}_{t} = {\sum }_{i} {α}_{t} ( {\tilde{q}}_{t} \cdot {\tilde{k}}_{i} ) \cdot {v}_{i} = {α}_{t} {\tilde{q}}_{t} \cdot ( {\sum }_{i} {\tilde{k}}_{i} ⊗ {v}_{i} ) \qquad ( 6 )$$

Then Σᵢ\tilde{k}ᵢ⊗vᵢ could be computed first with a cost

$$O ( {Mn}_{e}^{2} )$$

and its multiplication with q could be computed with a cost

$$O ( {Nn}_{e}^{2} ) .$$

The total cost is

$$O ( ( M + N ) {n}_{e}^{2} ) ,$$

which is linear with respect to the sequence length.

As discussed above, the architecture is applicable for multiple conditional embeddings so it is needed to fuse the information with query points. The normalized linear attention is able to handle arbitrary numbers of conditional embeddings in a lower computational cost.

Specifically, L conditional embeddings {Yₗ∈ [symbol] ^{N}^{ₗ}^{×n}^{ₑ}}_{1≤l≤L} encoding the input functions and extra information. The Queries Q=(qᵢ)=XW_{q}, Keys

$${K}_{l} = ( {k}_{i}^{l} ) = {YW}_{k} and Values {V}_{l} = ( {ν}_{i}^{l} ) = {YW}_{v}$$

can be calculated, and then every qᵢ and kᵢ can be normalized to be \tilde{q}ᵢ and \tilde{k}ᵢ. Then the cross-attention can be computed as:

$${z}_{t} = {\tilde{q}}_{t} + \frac{1}{L} {\sum }_{l = 1}^{L} {\sum }_{{i}_{l} = 1}^{{N}_{l}} {α}_{t}^{l} ( {\tilde{q}}_{t} \cdot {\tilde{k}}_{{i}_{l}} ) {v}_{{i}_{l}} \qquad ( 7 )$$

$$= {\tilde{q}}_{t} + \frac{1}{L} {\sum }_{l = 1}^{L} {α}_{t}^{l} {\tilde{q}}_{t} \cdot ( {\sum }_{{i}_{l} = 1}^{{N}_{l}} {\tilde{k}}_{{i}_{l}} ⊗ {v}_{{i}_{l}} ) \qquad ( 8 )$$

where

$${α}_{t}^{l} = \frac{1}{{\sum }_{j = 1}^{{N}_{l}} {\tilde{q}}_{t} \cdot {\tilde{k}}_{j}}$$

is the normalization coefficient. In this way, the cross-attention aggregates all information from input functions and extra information. The computational complexity of Eq. (8) is

$$O ( ( N + {\sum }_{l} {N}_{l} ) {n}_{e}^{2} )$$

also linear with sequence length.

Similar to the Cross-attention layer, the Self-attention for Queries can be calculated as:

$${z}_{t}^{′} = {\sum }_{i} {α}_{t} ( {\tilde{q}}_{t} \cdot {\tilde{k}}_{i} ) \cdot {v}_{i} \qquad ( 9 )$$

where all of q, k and v are computed with the embedding zₜ as

$${q}_{t} = {W}_{q} {z}_{t} , {k}_{t} = {W}_{k} {z}_{t} , {v}_{t} = {W}_{v} {z}_{t} \qquad ( 10 )$$

In the approach described above, the cascade of a cross-attention layer and a self-attention layer is used as a basic block of the model, and in an example, multiple blocks (shown as N in FIG. 2) can be used in the architecture.

In an example, multiple heads similar to other transformer models can also be used. The embedding zₜ and

$${z}_{t}^{′}$$

can be divided into H heads as

$${z}_{t} = Concat {( {z}_{t}^{i} )}_{i = 1}^{H} and {z}_{t}^{′} = Concat {( {z}_{t}^{′ i} )}_{i = 1}^{H} .$$

Each head

$${z}_{t}^{i}$$

can be updated using Eq. (7) and Eq. (9).

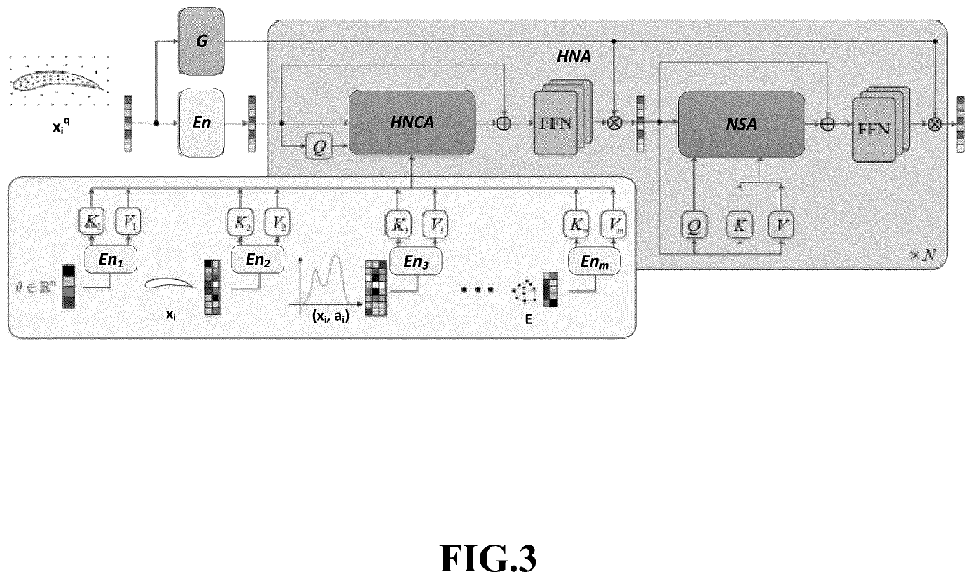

In order to handle multi-scale problems, a geometric gating mechanism based on mixture-of-experts (MoE) is disclosed herein. FIG. 3 illustrates an example model architecture of the proposed General Neural Operator Transformer (GNOT), in accordance with various aspects of the present disclosure.

MoE is a common technique in Transformers for improving model efficiency and capacity, which is improved to serve as a domain decomposition technique for dealing with multi-scale problems. The disclosed geometric gating network that inputs the coordinates of the query points and output unnormalized scores Gᵢ(x) for averaging these expert networks. In each layers of the attention block of the architecture shown in FIG. 3, the update of zₜ and

$${z}_{t}^{l}$$

in the feedforward layer (FFN) after Eq. (8) and Eq. (9) is replaced by equation below when having K expert networks for the MLP denoted by Eᵢ(·).

$${z}_{t} ← {z}_{t} + {\sum }_{i = 1}^{K} {p}_{i} ( {x}_{t} ) \cdot {E}_{i} ( {z}_{t} ) \qquad ( 11 )$$

The weights for averaging the expert networks are computed as

$${p}_{i} ( {x}_{t} ) = \frac{exp ( {G}_{i} ( {x}_{t} ) )}{{\sum }_{i = 1}^{K} exp ( {G}_{i} ( {x}_{t} ) )} \qquad ( 12 )$$

where the gating network G(·): [symbol] ^{d}→ [symbol] ^{K} takes the geometric coordinates of query points xₜ as inputs. The normalized outputs pᵢ(xₜ) are the weights for averaging theses expert networks.

The geometric gating mechanism could be viewed as a soft domain decomposition. There are several decision choices for the gating network. In an example, a simple MLP could be used to represent the gating network and its parameters can be learned end to end. In another example, available prior information could be embedded into the gating network. For example, the domain can be divided into several subdomains and thus the gating network can be fixed by handcraft. This is applicable when we have enough prior information about the problems. By introducing the gating module, the disclosed model could be naturally extended to handle large-scale and multi-scale problems.

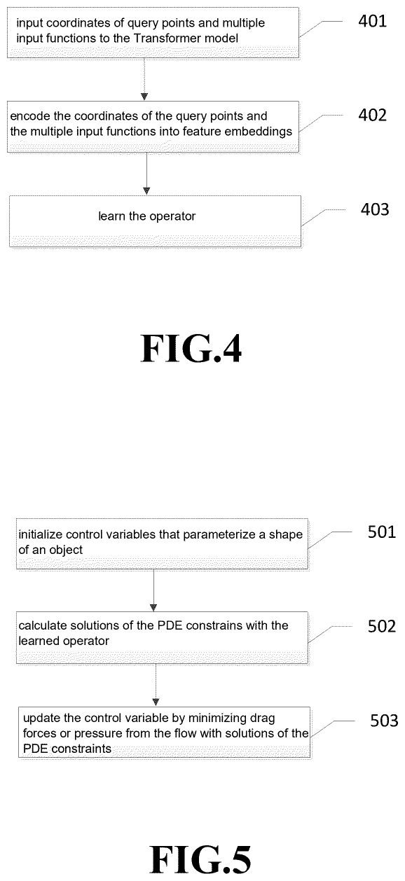

FIG. 4 illustrates an exemplary flow chart for learning an operator based on a Transformer model, in accordance with various aspects of the present disclosure. As described below, some or all illustrated features may be omitted in a particular implementation within the scope of the present disclosure, and some illustrated features may not be required for implementation of all embodiments. Further, some of the blocks may be performed parallel or in a different order. In some examples, the method may be carried out by any suitable apparatus or means for carrying out the functions or algorithm described below.

In a real-world application, systems like physics, chemistry and biology can be characterized by PDEs as input functions, such as boundary shape, global parameter vector and/or source functions. Specifically, for a structural optimization problem, the shape to be optimized could corresponding to a boundary function parameterized by global parameter vector, and the source functions could be Naiver-Stokes equations or other suitable functions. The Transformer model is to be trained to learn an operator mapping from the input functions to the solution function and then can be generalized to unseen inputs.

The method begins at block 401, with inputting coordinates of query points and the multiple input functions to the Transformer model.

As an example, the multiple input functions could be one or more of parameter vector, boundary shape, and/or domain distributed functions.

As an example, the multiple input functions and the solution function are discretized on irregular meshes. As a further example, information of the irregular meshes on which the multiple input functions are discretized is also input to the Transformer model. As a further example, the information of the irregular meshes comprises subdomain indicator of mesh points, and/or edge information between mesh points.

Then the method proceeds to block 402, with encoding the coordinates of query points and the multiple input functions into feature embeddings via respective encoders. As an example, the coordinates of query points and the multiple input functions are encoded by Multiple Layer Perceptrons (MLPs) which do not share parameters. As an example, the encoded feature embeddings of the coordinates of query points and the multiple input functions each have a dimension of an integral multiple of the dimension of embedding.

Then the method proceeds to block 403, with learning the operator by minimizing a mean square error (MSE) loss between output features processed by the Transformer model and ground-truth values of the solution function. In an example, the MSE loss minimized as Eq. (1).

As an example, the Transformer model is configured with multiple layers of attention block, and each attention block comprises a cross-attention layer followed by a self-attention layer. As a further example, the cross-attention layer and the self-attention layer are followed by multiple parallel Forward Feed Networks (FFNs) respectively. As a further example, the cross-attention layer and the self-attention layer are configured with multiple heads.

As a further example, the cross-attention between an output feature of a prior attention block and the feature embeddings of the multiple input functions is calculated in the cross-attention layer of each attention block, and the self-attention between the output feature of the prior attention block is calculated in the self-attention layer of each attention block. The feature embedding of the coordinates of query points is the input to the first attention block, the output feature embeddings of a prior attention block are treated as the input to the next attention block; while the feature embeddings of the multiple input functions are input to each attention block for calculating the cross-attention.

As an example, the cross-attention and the self-attention are calculated by Eq. (2).

As another example, the cross-attention and the self-attention are calculated by first normalizing sequences of Queries and Keys with softmax function and then computing the attention output without softmax function. As an example, the cross-attention and the self-attention are calculated by Eq. (6) and Eq. (9).

As a further example, since the model are input with multiple conditional embeddings, the cross-attention is calculated based on an aggregation of Keys and Values obtained from the feature embeddings of all of the multiple input functions. In an example, the cross-attention is calculated by Eq. (7).

As a further example, the coordinates of query points are input to a geometric gating block, and unnormalized scores for averaging the multiple parallel FFNs are output by the geometric gating block. Then processing of the cross-attention and the self-attention by the FFNs can be weighted with the unnormalized scores.

As a further example, the geometric gating block is an MLP which parameters is learned end-to-end. As another example, prior information is embedded into the geometric gating block and the parameters are fixed based on the prior information.

After the operator is learned by minimizing a mean square error (MSE) loss, the Transformer model can be used to simulate the system under different settings and parameters characterized by PDEs, which can be widely applicable in scenarios such as shape optimization or flow control, etc.

FIG. 5 illustrates an exemplary flow chart for using the learned operator, in accordance with various aspects of the present disclosure. As described below, some or all illustrated features may be omitted in a particular implementation within the scope of the present disclosure, and some illustrated features may not be required for implementation of all embodiments. Further, some of the blocks may be performed parallel or in a different order. In some examples, the method may be carried out by any suitable apparatus or means for carrying out the functions or algorithm described below.

The learned operator can be used for solving a PDE constrained shape optimization problem, wherein the physical system is characterized by the PDE constraints, the state variables of the PDE constraints include at least one of flow velocity or pressure.

The method begins at block 501, with initializing control variables that parameterizing a shape of an object. Then the method proceeds to block 502, based on the input coordinates of query points, the solutions of the PDE constraints can be calculated with the learned operator. Then the method proceeds to block 503, with updating the control variables by minimizing drag forces or pressure from the flow with the solutions of the PDE constraints.

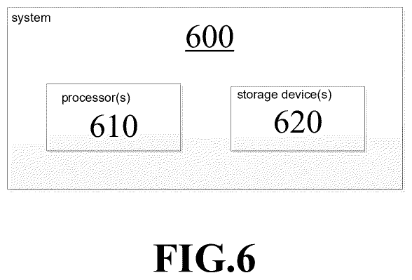

FIG. 6 illustrates an exemplary computer system 600, in accordance with various aspects of the present disclosure. The computer system may comprise at least one processor 610. The computer system may further comprise at least one storage device 620. It should be appreciated that the storage device 620 may store computer-executable instructions that, when executed, cause the processor 610 to perform any operations according to the embodiments of the present disclosure as described in connection with FIGS. 1-5.

The embodiments of the present disclosure may be embodied in one or more computer-readable medium such as non-transitory computer-readable medium. The non-transitory computer-readable medium may store instructions that, when executed, cause one or more processors to perform any operations according to the embodiments of the present disclosure as described in connection with FIGS. 1-5.

The embodiments of the present disclosure may be embodied in a computer program product comprising computer-executable instructions that, when executed, cause one or more processors to perform any operations according to the embodiments of the present disclosure as described in connection with FIGS. 1-5.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

The above description is provided to enable any person skilled in the art to practice the various aspects described herein. Various modifications to these aspects will be readily apparent to those skilled in the art, and the generic principles defined herein may be applied to other aspects. Thus, the present invention is not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the present invention.

1-18. (canceled)

19. A computer implemented method for learning an operator mapping from multiple input functions to a solution function of partial differential equations (PDEs) based on a Transformer model, the method comprising the following steps:
inputting coordinates of query points and the multiple input functions to the Transformer model;
encoding the coordinates of the query points and the multiple input functions into feature embeddings via respective encoders; and
learning the operator by minimizing a mean square error (MSE) loss between output features processed by the Transformer model and ground-truth values of the solution function.

20. The computer implemented method of claim 19, wherein:
the respective encoders are Multiple Layer Perceptrons (MLPs) which do not share parameters, and
the feature embeddings of the coordinates of the query points and the multiple input functions each have a dimension of an integral multiple of a dimension of the feature embedding.

21. The computer implemented method of claim 19, wherein the multiple input functions include one or more of: a global parameter vector, a boundary shape, and/or domain distributed functions.

22. The computer implemented method 19, wherein the multiple input functions and the solution function are discretized on irregular meshes.

23. The computer implemented method of claim 22, further comprising the following steps:
inputting information of the irregular meshes on which the multiple input functions are discretized to the Transformer model; and
encoding the information into the feature embeddings via the respective encoders.

24. The computer implemented method of claim 23, wherein the information of the irregular meshes includes subdomain indicator of mesh points, and/or edge information between mesh points.

25. The computer implemented method of claim 19, wherein:
the Transformer model is configured with multiple layers of attention blocks, and
each attention block includes a cross-attention layer followed by a self-attention layer.

26. The computer implemented method of claim 25, wherein each cross-attention layer and each self-attention layer are configured with multiple heads.

27. The computer implemented method of claim 25, further comprising the following steps:
calculating, in the cross-attention layer of each attention block, cross-attention between an output feature of a prior attention block and the feature embeddings of the multiple input functions; and
calculating, in the self-attention layer of each attention block, self-attention between an output feature of a prior attention block;
wherein the feature embeddings of the coordinates of the query points is input to a first of the attention blocks.

28. The computer implemented method of claim 27, wherein cross-attention and self-attention are calculated by first normalizing sequences of Queries and Keys with softmax function and then computing the attention output without softmax function.

29. The computer implemented method of claim 27, wherein cross-attention is calculated based on an aggregation of Keys and Values obtained from the feature embeddings of all of the multiple input functions.

30. The computer implemented method of claim 27, wherein the cross-attention layer and the self-attention layer are followed by multiple parallel Forward Feed Networks (FFNs) respectively.

31. The computer implemented method of claim 30, further comprising the following steps:
inputting the coordinates of the query points to a geometric gating block;
outputting unnormalized scores for averaging the multiple parallel FFNs by the geometric gating block; and
weighting processing of the cross-attention and the self-attention by the FFNs with the unnormalized scores.

32. The computer implemented method of claim 31, wherein:
the geometric gating block is an MLP which parameters is learned end-to-end, or
prior information is embedded into the geometric gating block and the parameters are fixed based on the prior information.

33. A computer implemented method for solving a Partial Differential Equation (PDE) constrained shape optimization problem in a physical system with a learned operator based on a Transformer model, wherein the physical system is characterized by the PDE constraints, state variables of the PDE constraints include at least one of flow velocity or pressure, the method comprising the following steps:
initializing control variables that parameterizing a shape of an object;
calculating solutions of the PDE constraints with the learned operator based on input coordinates of query points; and
updating the control variables by minimizing drag forces or pressure from the flow with the solutions of the PDE constraints.

34. The computer implemented method of claim 33, wherein the learned operator mapping from multiple input functions to a solution function of partial differential equations (PDEs) is learned by performing the following steps:
inputting coordinates of query points and the multiple input functions to the Transformer model;
encoding the coordinates of the query points and the multiple input functions into feature embeddings via respective encoders; and
learning the operator by minimizing a mean square error (MSE) loss between output features processed by the Transformer model and ground-truth values of the solution function

35. A computer system, comprising:
one or more processors; and
one or more storage devices storing computer-executable instructions that, when executed, cause the one or more processors to perform a method for learning an operator mapping from multiple input functions to a solution function of partial differential equations (PDEs) based on a Transformer model, the method comprising the following steps:
inputting coordinates of query points and the multiple input functions to the Transformer model;
encoding the coordinates of the query points and the multiple input functions into feature embeddings via respective encoders; and
learning the operator by minimizing a mean square error (MSE) loss between output features processed by the Transformer model and ground-truth values of the solution function.

36. One or more non-transitory computer readable storage media storing computer-executable instructions for learning an operator mapping from multiple input functions to a solution function of partial differential equations (PDEs) based on a Transformer model, the instructions, when executed by one or more processors, causing the one or more processors to perform the following steps comprising:
inputting coordinates of query points and the multiple input functions to the Transformer model;
encoding the coordinates of the query points and the multiple input functions into feature embeddings via respective encoders; and
learning the operator by minimizing a mean square error (MSE) loss between output features processed by the Transformer model and ground-truth values of the solution function.
